(19) United States
(12) Patent Application Publication
(10) Pub. No.: US 2005/0031119 A1
(43) Pub. Date: Feb. 10, 2005

(54) Method and communications device for secure group communication

(76) Inventor: Yuying Ding, Ottawa (CA)

Correspondence Address: OGILVY RENAULT, 1981 MCGILL COLLEGE AVENUE, SUITE 1600, MONTREAL, QC, H3A2Y3, CA

(21) Appl. No.: 10/632,975

(22) Filed: Aug. 4, 2003

(51) Int. Cl. H04K 1/00

(52) U.S. Cl. 380/28; 713/163

(57) ABSTRACT

A communications device and method for secure group communications in a highly dynamic environment permits group members to be readily added or removed from the group without compromising security. The communications device includes an orthogonal code generating module, an orthogonal code table, an encryption module and a decryption module. Group members exchange orthogonal codes with each other so that each member has a set of orthogonal encryption and decryption codes assigned by each of the other group members. A message sender may broadcast an amalgamated message assembled from a number of individually encrypted messages for different group members. A recipient extracts their message by decrypting the amalgamated message using the orthogonal decryption code received from the sender. Parts of the amalgamated message encrypted for other group members are transparent to the recipient.

### CROSS-REFERENCE TO RELATED APPLICATIONS

This is the first application filed for the present invention.

### MICROFICHE APPENDIX

Not Applicable.

### TECHNICAL FIELD

This invention relates in general to secure communications in a highly dynamic environment and, in particular to a method and communications device for enabling secure group communication in a highly dynamic environment

### BACKGROUND OF THE INVENTION

The development of Internet enabled group-oriented applications such as audio and video conferencing, stock quotes, and pay-per-view have become very popular. However, achieving secure and convenient group collaboration in a highly dynamic environment is a significant challenge for several reasons.

First, preventing a message exchanged among group members from being received or intercepted by non-members is a core problem of group communication. It requires authentication and secrecy. With respect to authentication, there are two types in common use—message authentication and source authentication. Message authentication only guarantees that a message was sent by a certified group member, without telling who sent the message. Source authentication identifies who sent the message and is therefore more desirable. Data secrecy requires not only data communication secrecy, but also secure forward secrecy, so that when a member leaves or is removed from a group, that member can no longer receive messages exchanged within the group. Likewise, data secrecy requires backward secrecy, so that when a new member joins a group, that member can receive an inspect only those messages exchanged within the group after the new member has joined.

Moreover, in some circumstances group members frequently leave and/or new members frequently join the group. It is therefore imperative that a solution be provided for supporting highly dynamic communications groups.

Scalability is another important criterion for evaluating group communication solutions, and a good solution must not rely on the architecture of the underlying network.

Group-oriented communication research is presently one of the fastest growing areas in the field of networking. There are two trends in current solutions for secure group communication. One is non-collaborative group key management, as taught, for example in RFC 2627 entitled Key Management for Multicast: Issues and Architectures, Wallner et al. (1999); Secure Group Communications Using Key Graphs, Wong et al. (1998); and U.S. Pat. No. 6,240,188, which issued May 20, 2001 to Dandeti et al., entitled Distributed Group Key Management Scheme for Many-to-Many Communications. The other is collaborative group key agreement, as taught, for example in an article entitled New Multiparty Authentication Services and Key Agreement Protocols; Ateniese et al., IEEE Journal of Selected Areas of Communications, Vol. 18, No. 4, April 2000; and Diffie-Hellman Key Distribution Extended to Group Communication, Steiner et al. third ACM Conference on Computer and Communications Security. Each of these solutions is based on establishing a group key shared by all members, and re-keying when group members change. Consequently, performance is degraded in large groups with frequent membership changes.

The representative non-collaborative group key management solutions are the tree-based solutions. Typical collaborative key agreement solutions are based on Diffie-Hellman key exchanges. Tree-based solutions rely on a trusted central controller for key distribution and management. Although they work well in relatively static groups, they are not appropriate in certain circumstances. For example, in ad hoc wireless networks where a fixed central control is non-existent or difficult to identify. In addition, such systems are vulnerable because there is a signal point of failure (or attack).

The peer-to-peer collaborative group key agreement solutions have certain desirable features, such as distributed key management, key authentication and key confirmation. However, they are too complex and computationally intensive for practical use.

There therefore exists a need for a method and communications device for secure group communication that is reliable and practical to use.

### SUMMARY OF THE INVENTION

It therefore is an object of the invention to provide a method and communications device for secure group communication that is easy to implement and practical to use.

The invention therefore provides a communications device for secure communications in a highly dynamic environment between members of a predefined communications group that includes a plurality of group members. The communications device comprises an orthogonal code module for maintaining an orthogonal code table by reciprocally exchanging an orthogonal code with a communications device operated by each new member that joins the group, and deleting from the table the orthogonal code associated with the communications device of any group member that leaves the group; an encryption module for encrypting a message to be sent to one or more of the group members using the orthogonal code associated with respective communications devices operated by the group members to which the message is to be sent; and a decryption module for decrypting a message sent from a communications device operated by any of the other group members.

The invention also provides method of providing secure communications in a highly dynamic environment between members of a predefined communications group that includes a plurality of group members. The method comprises maintaining an orthogonal code table for each group member by reciprocally exchanging an orthogonal code with each new member that joins the group, and deleting from the table the orthogonal code associated with any group member that leaves the group; encrypting a message to be sent to one or more of the group members using the orthogonal code associated with respective group members to which the message is to be sent; and decrypting a message sent from a communications device operated by any of the other group members.

The invention therefore supports source authentication because for any recipient of a message, there is a specific orthogonal code associated with a sender of the message, and the recipient can only decrypt a message sent by the sender using the specific orthogonal code.

The invention also provides not only data communication secrecy but also forward access and backward access secrecy. Since the orthogonal codes used by the respective group members are pseudo-random and independent, if a member leaves a group and the related orthogonal codes are deleted, the former member cannot decrypt future communications among the group members within a reasonable period of time. Similarly, if a new member joins, new orthogonal codes will be assigned to the new member, but with those newly assigned orthogonal codes, the new member cannot deduce the orthogonal codes of others within a reasonable period of time, or decrypt the communications conducted prior to the time that the member joined the group.

The invention also adapts well to highly dynamic situations because there is no group key formation and re-keying problem involved. Consequently, there is little communications overhead that results from a membership change.

The invention requires no assumptions about the underlying network, and the message length is not linearly related to the number of message recipients. The invention therefore demonstrates excellent scalability.

Finally, the invention can be used even though the communications devices of the respective group members have a wide range of different capabilities.

Moreover, the invention is very flexible because each member makes an independent decision about whether to exchange orthogonal codes with other group members. Therefore, the invention achieves secure communication within arbitrary subgroups, as well as providing both one-way and two-way secure communications within a group at the same time.

### BRIEF DESCRIPTION OF THE DRAWINGS

Further features and advantages of the present invention will become apparent from the following detailed description, taken in combination with the appended drawings, in which:

FIG. 1 illustrates an exemplary structure of an orthogonal code table stored by each group member;

FIG. 2 illustrates an exemplary preparation process for orthogonal code exchange;

FIG. 3 illustrates the format of an orthogonal codes exchange message;

FIG. 4 illustrates an orthogonal code exchange between group members;

FIG. 5 illustrates a procedure for amalgamating a number of messages for a number of group members;

FIG. 6 is a flow diagram that illustrates a message encryption process in accordance with the invention;

FIG. 7 is a flow diagram that illustrates message amalgamation in accordance with the invention;

FIG. 8 illustrates a procedure for extracting a message from a received amalgamated message; and

FIG. 9 illustrates a process required when a member leaves the group or a new member joins the group.

It will be noted that throughout the appended drawings, like features are identified by like reference numerals.

### DETAILED DESCRIPTION OF THE PREFERRED EMBODIMENT

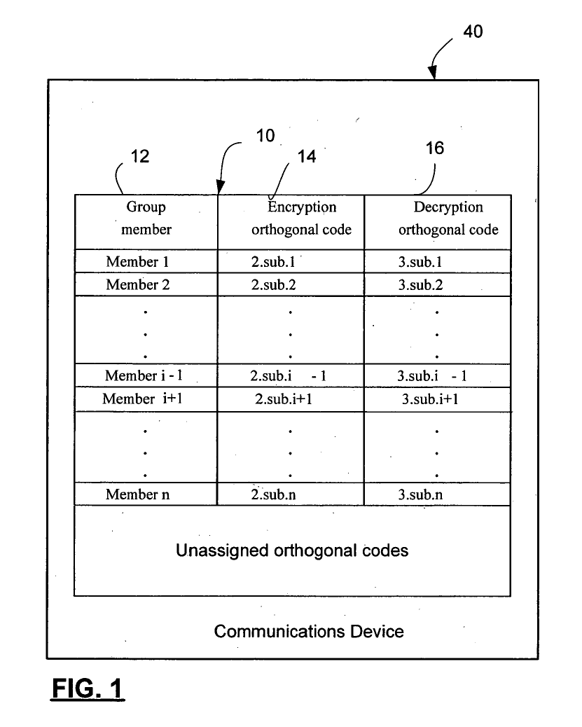

FIG. 1 illustrates an exemplary structure for an orthogonal code table 10 in accordance with the invention stored on a communications device belonging to each group member. As shown, there is a group member list 12 that stores the identifiers of all other group members, a corresponding encryption orthogonal code list 14, and a corresponding decryption orthogonal code list 16. The encryption orthogonal code list 14 stores the orthogonal codes assigned by the owner of the table to the members of the group member list 12. Correspondingly, the decryption orthogonal code list 16 stores the orthogonal codes assigned by the members of the group member list to the owner of the secure code table 10.

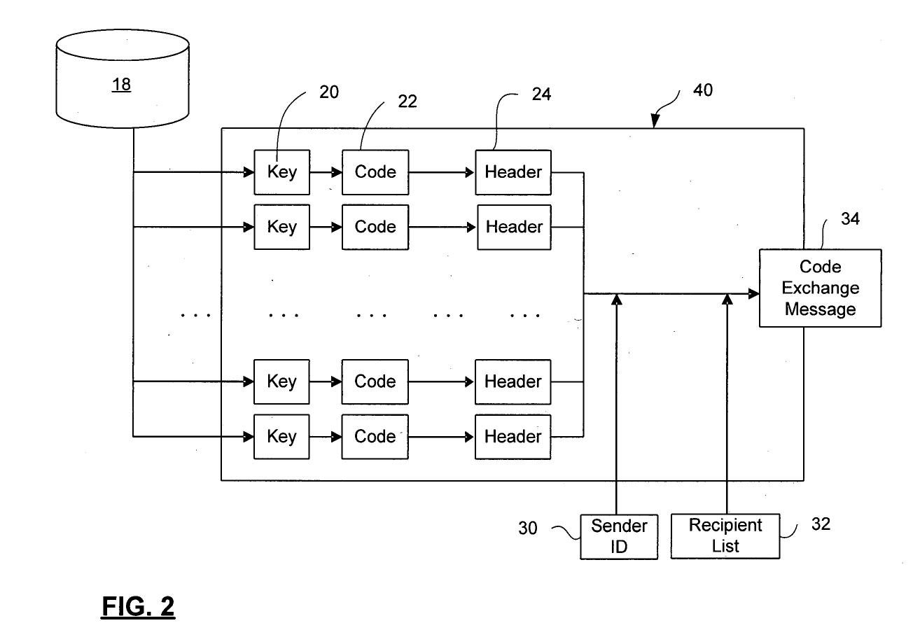

FIG. 2 illustrates the process of preparing orthogonal codes for exchange with the group members. As shown, the preparation process includes the following steps:
a) A member queries a credentials database 18 for any encryption means or encryption keys 20 belonging to an orthogonal code recipient. The encryption key 20 can be a public key or a symmetric key depending on the data stored in the credentials database 18 by the orthogonal code recipient.
b) The member encrypts an orthogonal code 22 that it assigns to the recipient using the encryption means or encryption key 20 to obtain an encrypted orthogonal code 24.
c) The encrypted orthogonal code 24 is encapsulated with an secure header 26.
d) After all other group member orthogonal codes are encrypted, the member concatenates all the encapsulated encrypted orthogonal codes into a code message 28, adds the sender ID 30 and the recipient list 32 to form an orthogonal codes exchange message 34.

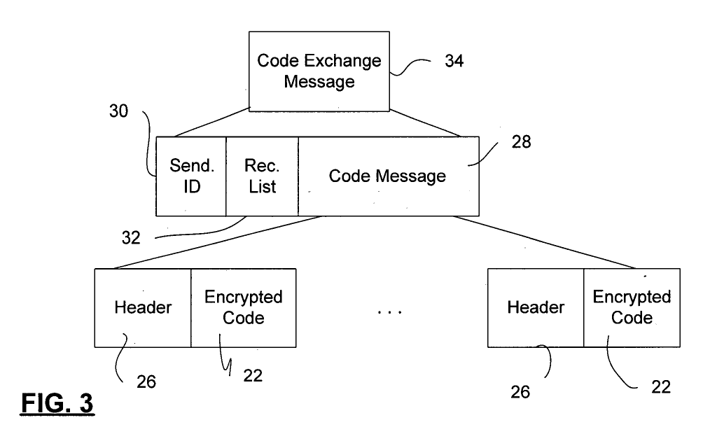

FIG. 3 shows the format of an orthogonal codes exchange message 34, which includes the sender ID 30, the recipient list 32, and a concatenate encrypted code message 28. Each part of the concatenated encrypted code message 28 includes an secure header 26 and an encrypted orthogonal code 24. The secure header 26 contains a key identifier and a bit indicating the encryption means employed for orthogonal code exchange with the corresponding recipient.

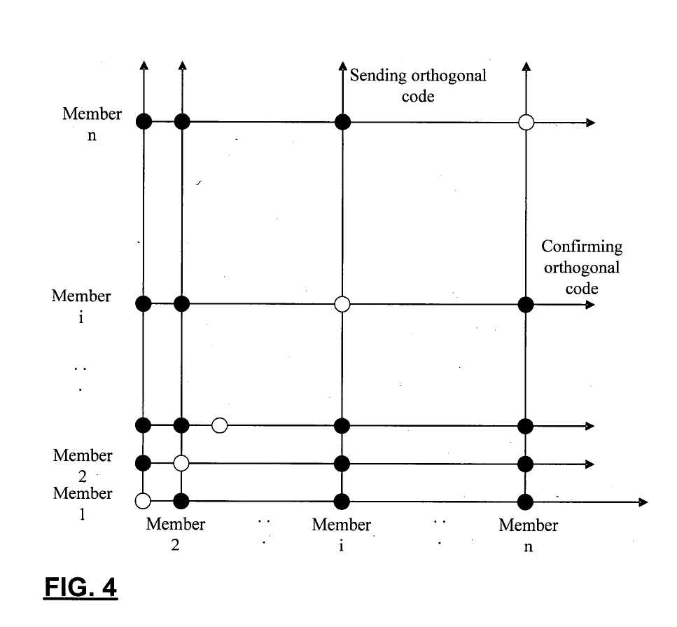

FIG. 4 illustrates an orthogonal codes exchange among group members. As shown, each member broadcasts an orthogonal codes exchange message 34 to all other members. When a member receives the orthogonal codes exchange, message 34, the group member's communications device locates its copy of the encrypted orthogonal code using the key identifier in the header 26 and uses the appropriate decryption means to decrypt the orthogonal code.

FIG. 4 further shows that after a recipient receives the orthogonal code exchange messages 34 from one or more group members, the communications device broadcasts an amalgamated orthogonal code confirmation to all group members from which a code message 34 was received. The procedure for generating an amalgamated orthogonal code confirmation is the same as the procedure of amalgamating any other message which will be explained below in detail. In accordance with the invention, broadcast is preferably used for message distribution to save communication overhead.

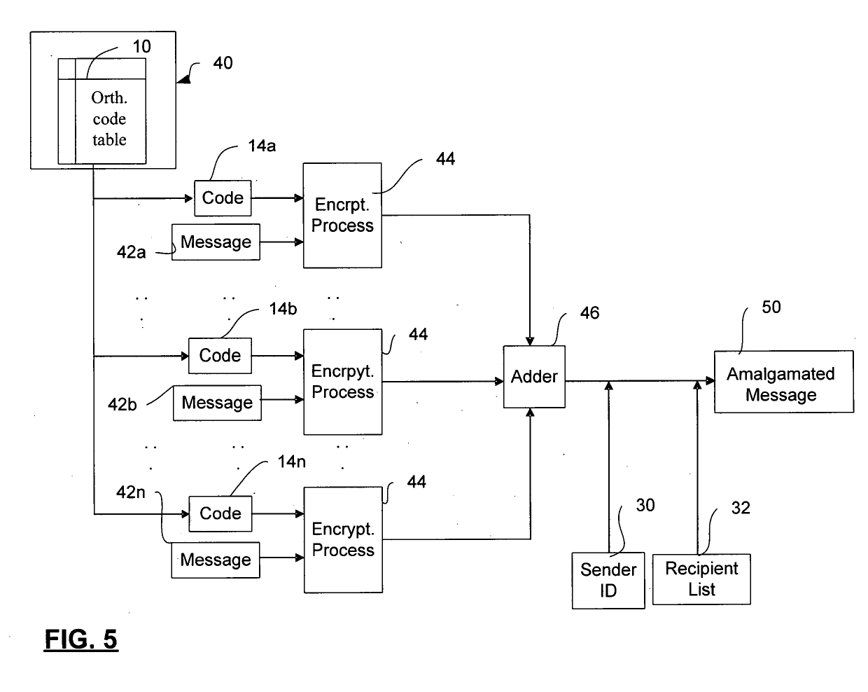

FIG. 5 illustrates the procedure for amalgamating messages for two or more group members. As shown, a communications device 40 owned by a group member encrypts a message 42 for a recipient by encrypting it (44) using the encryption orthogonal code 14 obtained from the orthogonal code table 10. The sender encrypts two or more messages for two or more recipients in parallel, and the communications device 40 outputs the encrypted messages to an adder 46, which outputs an amalgamated secure message 50. The adder 46 may be implemented in parallel to improve the performance. In addition, the messages 42a-42n for the different recipients may be the same or different, so that arbitrary group members can be selected as a subgroup to receive an identical message.

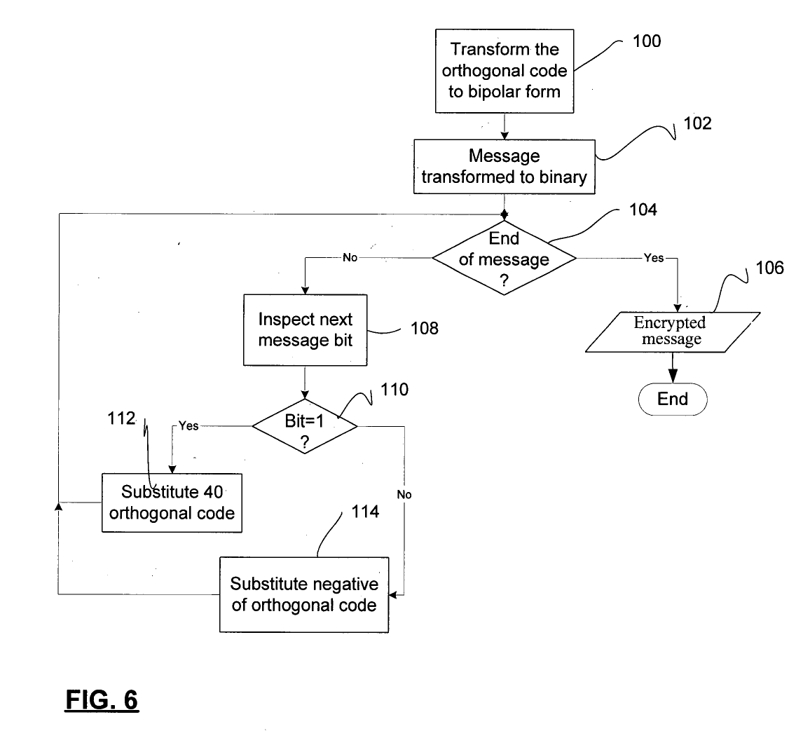

FIG. 6 is a flow diagram of an exemplary message encryption process. The process starts at step 100 in which the encryption orthogonal code is transformed to bipolar form (‘1’ transformed to ‘+1’; ‘0’ transformed to ‘−1’). The procedure proceeds to step 102 in which the message to be sent is transformed to binary (0,1) form. At step 104, it is determined whether the end of the message has been reached, which indicates that message encryption is complete. If so, then the resulting encrypted message is output to the adder 106. If not, the process advances to step 108 and a next bit of the binary message is inspected. The content of the bit determines one of the three actions:
if the bit is a “1” (step 110), the bit is replaced with the encryption orthogonal code, and the process returns to step 104;
if the bit is a “0” (step 114), the bit is replaced with a negative of the encryption orthogonal code, and the process returns to step 104.

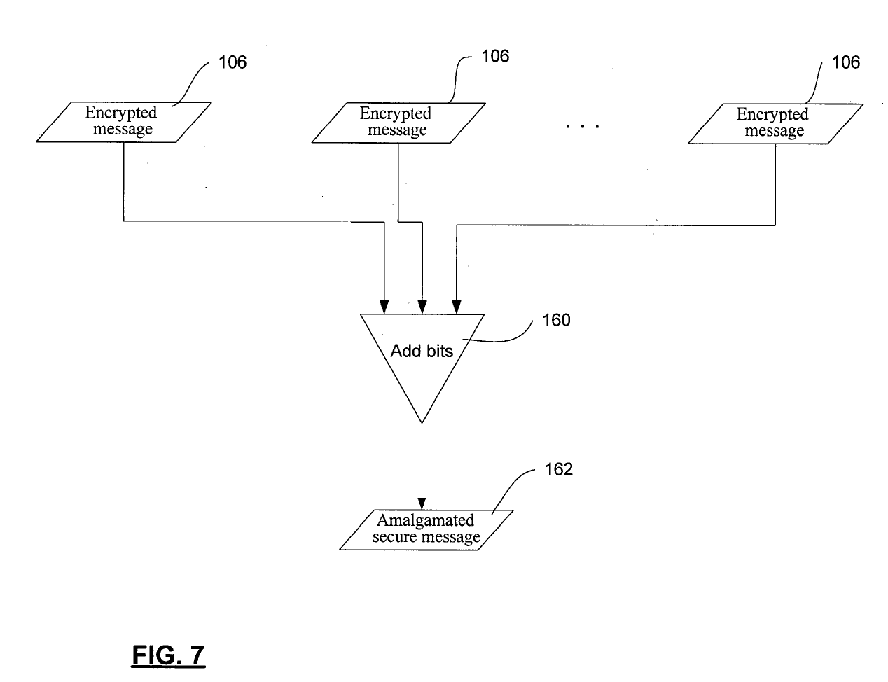

FIG. 7 is a flow diagram of message amalgamation. After the messages for all recipients are encrypted and output to the adder (step 106), those encrypted messages are added together bit by bit at step 160, and an amalgamated secure message is generated at step 162.

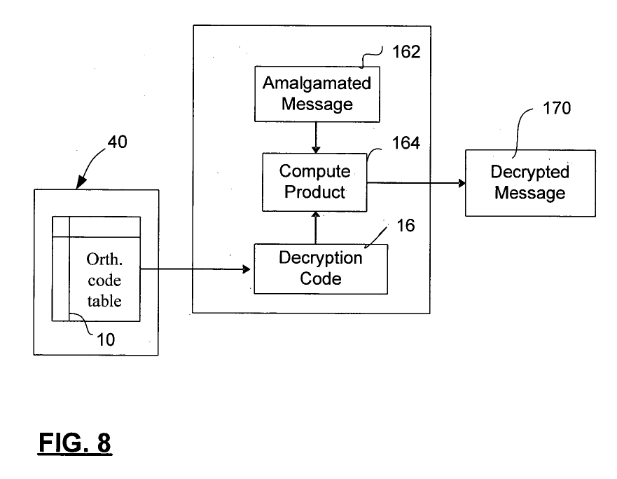

FIG. 8 illustrates an exemplary process for extracting a message from a received amalgamated message. When a communications device 40 operated by a group member receives an amalgamated message 162, the communications device 40 accesses its orthogonal code table 10 to retrieve the corresponding decryption orthogonal code 16 associated with the sender ID 12 of the sender. The communications device 10 extracts the message 170 intended for the recipient by computing a normalized inner product of the amalgamated secure message 162 and decryption orthogonal code 16. Due to the secure property of the codes, only the group member who has the corresponding orthogonal code can retrieve the appropriate part of the message, as will be explained below in more detail. At the same time, any recipient who does not possess the sender's orthogonal codes 14 cannot decode the message or any other part of a message except that part intended for them.

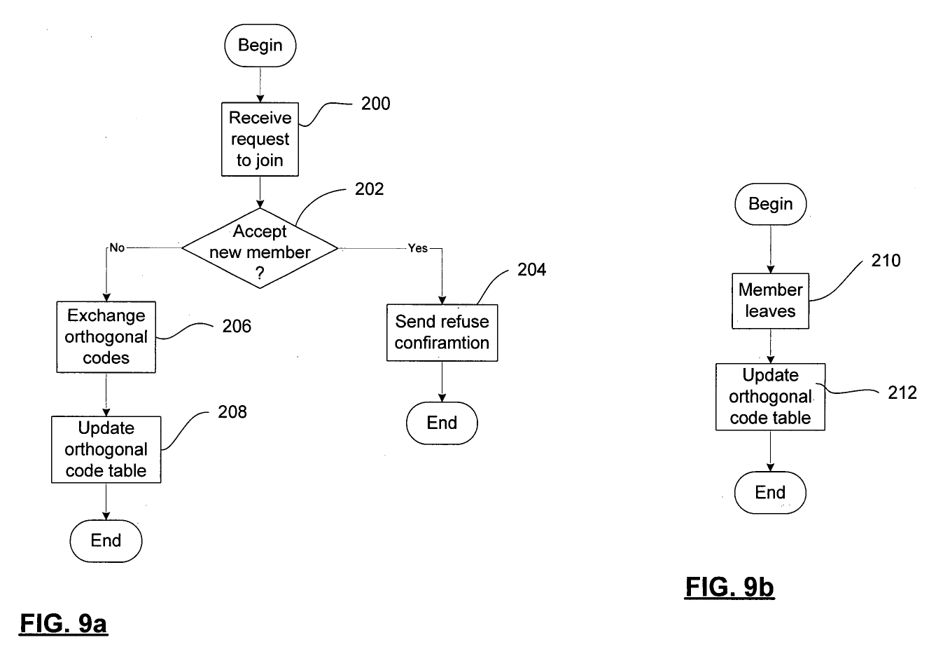

FIG. 9 illustrates the process when a member leaves or a new member joins a communications group. If a new member wants to join the group, as shown in FIG. 9(a), the process begins at step 200 where the new member sends a join request to all the members that the member wishes to securely communicate with. At step 202, each member decides independently if they will accept communications from the new member. If not, the member returns a refuse confirmation at step 204. Otherwise, the recipient exchanges orthogonal codes with the new member using the process as illustrated in FIG. 2, omitting the concatenation process. Likewise, the new member sends orthogonal codes to the accepting members using the process illustrated in FIG. 2.

When a member leaves (step 210) the group, as shown in FIG. 9(b), all remaining group members update (step 212) their orthogonal code table 10 by deleting the row used to store codes for the departing member.

Code Generation

There are several algorithms that may be used for orthogonal code generation, such as an secure variable spreading factor (OVSF) Code Generator, a Hadamard Code Generator, or a Walsh code generator, for example.

Code Example

In the following, an orthogonal code generated by the OVSF code generator is used as an example for illustrating the encryption and decryption algorithms.

In this example, there are four group members. S is a sender and A, B, C are recipients. The orthogonal codes for A, B and C are [1, 1, −1, −1], [1, −1, 1, −1], and [1, −1, −1, 1] respectively. Those skilled in the art will understand that these example codes are used for simplicity of illustration only, and are not intended to represent an actual implementation. In general, the code length will be considerably longer than show here by way of illustration.

In a first example, S sends a binary message “101” to A, B and C.

Message Preparation:

Encryption:
   For A, the encrypted message is: [1,1,−1,−1,−1, −1,1,1,1,1,−1,−1] (1)
   For B, the encrypted message is: [1,−1,1,−1,−1, 1,−1,1,1,−1,1,−1] (2)
   For C, the encrypted message is: [1,−1,−1,1, −1,1,1,−1,1,−1,−1,1] (3)
Amalgamation:
   Add (1), (2), and (3)
   Resulting message is: [3,−1,−1,−1,−3,1,1,1,3, −1,−1, −1] (4)
Decryption:
   When A gets the message (4), the internal product is computed and formalized:
      (4)·[1,1,−1,−1]*1/4=[(3−1+1+1), (−3+1−1−1), (3−1+1+1)]*1/4=[1,−1,1]
   i.e. the message recovered is “101”
   Similarly, B and C recover the message using the same process.

As a further example, suppose S sends “10” to A, “01” to B, “11” to C.

Message preparation:

Encryption:
   For A, the encrypted message is: [1,1,−1,−1,−1, −1,1,1] (1)
   For B, the encrypted message is: [−1,1,−1,1,1, −1,1,−1] (2)
   For C, the encrypted message is: [1,−1,−1,1,1,−1, −1,1] (3)
Amalgamation:
   Add (1), (2), and (3)
   Resulting message is: [1,1,−3,1,1,−3,1,1] (4)
Decryption:
   When A receives the message (4), the internal product is computed and formalized:
      (4)·[1,1,−1,−1]*1/4=[(1+1+3−1), (1−3−1−1)]*1/4=[1,−1]
   The message recovered is “10”.
   When B receives the message (4) the internal product is computed and formalized:
      (4)·[1,−1, 1,−1]*1/4=[(1−1−3−1), (1+3+1−1)]*1/4=[−1,1]
   The message recovered is “01”.
   When C receives the message (4), the internal product is computed and formalized:
      (4)·[1,−1,−1,1]*1/4=[(1−1+3+1), (1+3−1+1)]*1/4=[1,1]
   The message recovered is “11”.

As will be understood from the above example by those skilled in the art, more compact messages can be achieved using the methods in accordance with the invention if a user assigns more than one encryption code to each other group member with which the user communicates.

The invention therefore provides a method and a communications device 40 for enabling secure communications among members of a group in a highly dynamic environment, such as a wireless fidelity or an Internet environment where others apart from group members may receive or intercept messages exchanged between group members.

The embodiment(s) of the invention described above is(are) intended to be exemplary only. The scope of the invention is therefore intended to be limited solely by the scope of the appended claims.

1. A communications device for secure communications in a highly dynamic environment between members of a predefined communications group that includes a plurality of group members, comprising:
an orthogonal code module for maintaining an orthogonal code table by reciprocally exchanging an orthogonal code with a communications device operated by each new member that joins the group, and deleting from the table the orthogonal code associated with the communications device of any group member that leaves the group;
an encryption module for encrypting a message to be sent to one or more of the group members using the orthogonal code associated with respective communications devices operated by the group members to which the message is to be sent; and
a decryption module for decrypting a message sent from a communications device operated by any of the other group members.

2. The communications device as claimed in claim 1 further comprising an orthogonal code generator module for generating the orthogonal codes.

3. The communications device as claimed in claim 1 further comprising a message amalgamating module for amalgamating a number of messages addressed to other group members into an amalgamated message.

4. The communications device as claimed in claim 2 wherein said orthogonal code module comprises an orthogonal generator for generating a set of orthogonal and pseudo random orthogonal codes that are of identical length.

5. The communications device as claimed in claim 1 wherein said orthogonal code table comprises a group member list, an encryption orthogonal code list, a decryption orthogonal code list and an unused orthogonal code list.

6. The communications device as claimed in claim 3 wherein said message amalgamating module comprises a plurality of adders that output an amalgamated message by adding together encrypted messages addressed to a plurality of group members encrypted using respective encryption orthogonal codes associated with communications devices operated by the group members to which the respective messages are addressed.

7. The communications device as claimed in claim 6 wherein said encryption module comprises an orthogonal code transformation function, a binary transformation module and an encryption function.

8. The communications device as claimed in claim 6 wherein said orthogonal code transformation function transforms an encryption orthogonal code to bipolar form in which each orthogonal code ‘1’ is converted to ‘+1’, and each orthogonal code ‘0’ is converted to ‘−1’.

9. The communications device as claimed in claim 6 wherein said binary transformation module transforms the messages into a binary format.

10. The communications device as claimed in claim 9 wherein the encryption function accepts the message in binary format as input, examines each bit of the message and substitutes the bit with the encryption orthogonal code when the bit is “1” and a negative of said orthogonal code when the bit is “0”.

11. The communications device as claimed in claim 10 wherein a plurality of encryption functions work in parallel so that a number of messages are encrypted concurrently.

12. The communications device as claimed in claim 6 wherein the plurality of adders comprise parallel adders and a combining adder for combining outputs of the plurality of parallel adders.

13. The communications device as claimed in claim 12 wherein the parallel adders add the encrypted messages bit by bit in parallel, and output the sum to the combining adder.

14. The communications device as claimed in claim 13 wherein the combining adder accepts the outputs of the parallel adders and adds the accepted outputs bit by bit to generate the amalgamated message.

15. The communications device as claimed in claim 1 wherein said decryption module comprises
a function for accessing to the orthogonal code table to obtain a decryption orthogonal code associated with the communications device operated by the group member who sent the message; and
a function for computing a normalized inner product of the decryption orthogonal code and the received message to decrypt the message.

16. The communications device as claimed in claim 1 wherein said orthogonal code module comprises a function for sending an orthogonal code to each new group member and a function for confirming receipt of an orthogonal code by the new group member.

17. The communications device as claimed in claim 16 wherein the function for sending orthogonal codes comprises means for encrypting respective orthogonal codes for a number of recipients, concatenating the encrypted orthogonal codes and broadcasting the concatenated orthogonal codes.

18. A method of providing secure communications in a highly dynamic environment between members of a predefined communications group that includes a plurality of group members, comprising:
maintaining an orthogonal code table for each group member by reciprocally exchanging an orthogonal code with each new member that joins the group, and deleting from the table the orthogonal code associated with any group member that leaves the group;
encrypting a message to be sent to one or more of the group members using the orthogonal code associated with respective group members to which the message is to be sent; and
decrypting a message sent from a communications device operated by any of the other group members.

19. The method as claimed in claim 18 wherein exchanging an orthogonal code with each new member that joins the group further comprises encrypting the orthogonal code prior to sending the orthogonal code to the new member.

20. The method as claimed in claim 19 wherein the encrypting comprises encrypting each orthogonal code using one of:
symmetric encryption if a sender of the orthogonal code has a pre-arranged shared symmetric key with the recipient, and otherwise using public key encryption with a public key of the recipient.

21. The method as claimed in claim 20 wherein said pre-arranged shared symmetric key is exchanged offline between the two parties before the secure group communication occurs.

22. The method as claimed in claim 20 wherein the public key is obtained from a directory service.

23. The method as claimed in claim 18 further comprising a step of confirming the exchange of orthogonal codes with each member, comprising:
collecting all orthogonal codes sent during a predetermined period of time;
encrypting acknowledgements for each member that sent an orthogonal code using the an encryption module, and broadcasting a resulting amalgamated encrypted acknowledgement message.

24. The method as claimed in claim 18 further comprising:
periodically generating a new set of orthogonal codes using an orthogonal code generating module;
assigning said new set of orthogonal codes to respective other group members;
encrypting and amalgamating the assigned orthogonal codes to form a new code message;
sending the new code message to the other group members; and
recording the update in related orthogonal code tables.

25. The method as claimed in claim 18 wherein when a member leaves the group, the method further comprises:
deleting the encryption code assigned to said leaving member;
deleting the decryption code assigned by said leaving member; and
deleting an identity of the leaving member from a group members list.

26. The method as claimed in claim 18 wherein when a new member joins the group, the method further comprises:
sending a join request to all group members with which the new member desires secure communications;
receiving a refusal acknowledgment from each group member that does not desire secure communications with the new member;
exchanging orthogonal codes with each group member that accepts communications with the new member; and
updating the orthogonal code table as the orthogonal codes are received from other group members.
